(19) United States
(12) Patent Application Publication
(10) Pub. No.: US 2026/0299481 A1
(43) Pub. Date: Oct. 1, 2026

(54) POST-PROCESSING APPARATUS AND IMAGE FORMING APPARATUS THAT BOND SHEET BUNDLE WITH ADHESIVE

(71) Applicant: CANON KABUSHIKI KAISHA, Tokyo (JP)

(72) Inventor: NOBUTOSHI SUGAI, Shizuoka (JP)

(21) Appl. No.: 19/573,147

(22) Filed: Mar. 20, 2026

(30) Foreign Application Priority Data
Mar. 25, 2025 (JP) 2025-050554

(51) Int. Cl. G03G 15/00; G03G 15/20

(52) U.S. Cl. CPC G03G 15/5054; G03G 15/2064; G03G 15/5025; G03G 15/6567

(57) ABSTRACT

A post-processing apparatus includes a conveyance unit configured to convey a sheet to which an adhesive has been applied, a support unit configured to support the conveyed sheet, a bonding unit movable relative to the support unit to bond a sheet bundle using the adhesive, and a control unit configured to control the conveyance unit and the bonding unit. The control unit operates in a first mode in which a subsequent sheet is stacked on a preceding sheet bundle while bonding processing is performed, and a second mode in which stacking is performed after completion of bonding processing. The second mode is selected when a condition indicating reduced post-processing performance is satisfied, and the first mode is otherwise selected.

### BACKGROUND

### Field of the Technology

The present disclosure relates to a post-processing apparatus and an image forming apparatus that bond a sheet bundle with an adhesive.

### Description of the Related Art

Booklets have been conventionally produced by binding a plurality of sheets with staples, but a sheet processing apparatus has been proposed that produces booklets by bonding a plurality of sheets together using a toner image in place of staples (Japanese Patent Laid-Open No. 2023-164082). Japanese Patent Laid-Open No. 2023-164082 describes overlapping a period for processing for bonding a plurality of sheets stacked on a stacking section with a period for processing for stacking a subsequent sheet on the stacking section.

Incidentally, there are cases where, when a sheet passes through a fixing member, moisture absorbed in the sheet evaporates, causing the sheet to curl. When bonding processing is executed on a plurality of curled sheets, the sheets are pressed in the thickness direction in the vicinity of one of the two sides thereof that are parallel to the sheet conveyance direction, while the other side is lifted in the direction normal to the sheet surface (curl of the sheets). In this case, a subsequent sheet comes into contact with a curled portion of the sheets that are undergoing the bonding processing, thereby disturbing stackability of the subsequent sheet. There are also other conditions under which bonding processing for bonding a preceding sheet bundle and stacking processing for stacking a subsequent sheet cannot be executed in parallel.

### SUMMARY

The disclosure provides a post-processing apparatus comprising a conveyance unit configured to convey a sheet to which an adhesive was applied, a support unit configured to accept and support the sheet conveyed by the conveyance unit, a bonding unit configured to move relative to the support unit and to bond, with the adhesive, a sheet bundle formed by a plurality of sheets and supported by the support unit, and a control unit configured to control the conveyance unit and the bonding unit and having a first mode in which, while the bonding unit is executing bonding processing on a preceding sheet bundle, a subsequent sheet is stacked on the preceding sheet bundle, and a second mode in which, after bonding processing performed on a preceding sheet bundle by the bonding unit is complete, a subsequent sheet is stacked on the preceding sheet bundle, wherein the second mode is selected in a case where a condition according to which post-processing performance of the subsequent sheet decreases relative to the preceding sheet bundle is satisfied, and the first mode is selected in a case where the condition is not satisfied.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming system.

FIGS. 2A-2C are diagrams illustrating a print region for an adhesive image.

FIGS. 3A-3D are diagrams illustrating operations of a stacking section.

FIGS. 4A-4D are diagrams illustrating operations of the stacking section.

FIGS. 5A and 5B are diagrams illustrating operations of a heat-press unit.

FIG. 6 is a diagram illustrating a controller.

FIG. 7 is a flowchart showing a mode switching method.

FIG. 8 is a diagram illustrating operations of an intermediate stacking section.

FIG. 9 is a diagram illustrating operations of the intermediate stacking section.

FIGS. 10A-10F are diagrams illustrating a method for producing a booklet using large-sized sheets.

FIG. 11 is a flowchart showing a mode switching method that is based on a sheet size.

FIG. 12 is a diagram illustrating an image forming system.

FIGS. 13A-13D are diagrams illustrating operations of a stacking section.

FIGS. 14A-14D are diagrams illustrating operations of the stacking section.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Image Forming System

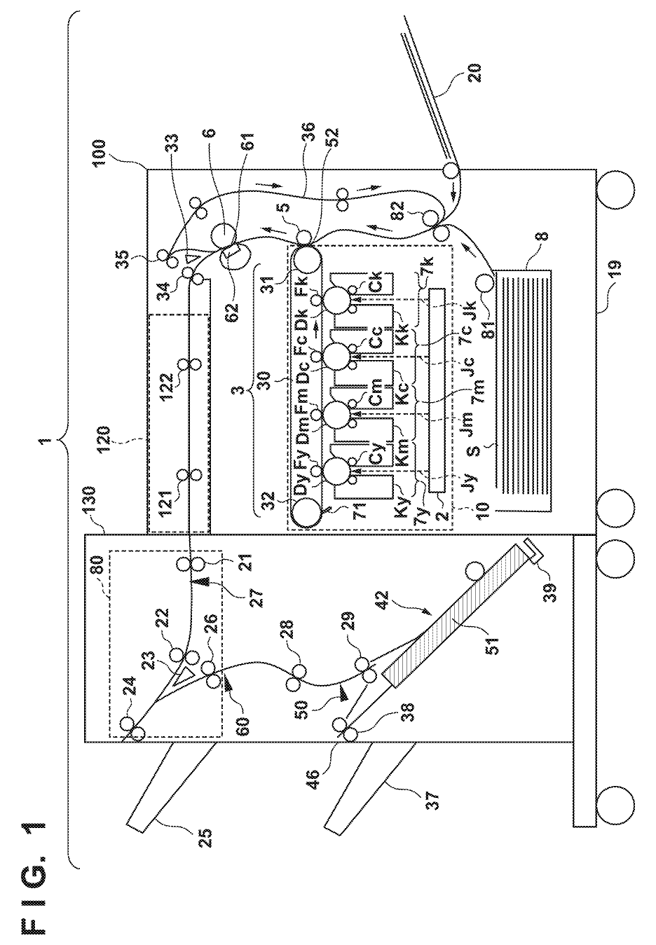

As shown in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S that is a recording material. An intermediate conveyance unit 120 conveys the sheet S on which the image has been formed to the post-processing apparatus 130. The post-processing apparatus 130 performs post-processing on the sheet S as necessary and outputs the resultant. Note that the image forming system 1 may be understood as a booklet producing apparatus, or the post-processing apparatus 130 may be understood as a booklet producing apparatus. The image forming system 1 may be referred to as an image forming apparatus.

The image forming apparatus 100 includes a fixing device 6, a sheet cassette 8, an image forming section 10, and a case 19 that accommodates them. The image forming section 10 forms a toner image on the sheet S supplied from the sheet cassette 8. The fixing device 6 executes fixing processing for fixing the toner image to the sheet S.

The sheet cassette 8 is provided in a lower portion of the image forming apparatus 100. The sheet cassette 8 is inserted into the case 19 in a drawable manner, and is capable of accommodating a large number of sheet S. In the present embodiment, it is assumed that the maximum size of a sheet S on which an image can be formed is the A4 size (297 mm in length × 210 mm in width). The long sides of the A4-sized sheet S are parallel to the conveyance direction of the sheet S. A supply roller 81 supplies the sheet S from the sheet cassette 8 and delivers the sheet S to a pair of conveyance rollers 82. A multi-tray 20 is also capable of supplying sheets S one by one.

The image forming section 10 is a tandem-type electrophotographic unit including four process cartridges 7y, 7m, 7c, and 7k, an exposure device 2, and a transfer unit 3. The characters y, m, c, and k represent yellow, magenta, cyan, and black, respectively. Instead of black, transparent toner (powder adhesive) may also be employed. Toner used as the powder adhesive may also be referred to as adhesive toner. The characters y, m, c, and k indicating toner colors may be omitted from reference signs. The adhesive toner may be transparent or may have a black color. When the adhesive toner is transparent, yellow, magenta, and cyan may be mixed as appropriate to realize black (process black). The types (materials) of the yellow toner, magenta toner, and cyan toner and the toner used as the adhesive toner are, for example, thermoplastic resins. Examples of the thermoplastic resins include polyester resins, vinyl-based resins, acrylic resins, styrene-acrylic resins, and the like. The process cartridges 7y, 7m, 7c, and 7k enable a plurality of components responsible for an image forming process to be integrally replaced. In other words, a plurality of components are integrated to form the process cartridges 7y, 7m, 7c, and 7k. Note that the arrangement order of the process cartridges 7y, 7m, 7c, and 7k in a rotation direction of a transfer belt 30 is merely an example. The process cartridges 7y, 7m, 7c, and 7k are examples of replaceable consumable components.

The process cartridges 7y, 7m, 7c, and 7k include corresponding developing devices Ky, Km, Kc, and Kk, photosensitive member drums Dy, Dm, Dc, and Dk, and charging rollers Cy, Cm, Cc, and Ck. The process cartridges 7y, 7m, 7c, and 7k have substantially the same structure except for the types of toner.

The developing devices Ky, Km, Kc, and Kk include containers that accommodate powder (e.g., toner) and application rollers (application sleeves) configured to apply the powder to the photosensitive member drums Dy, Dm, Dc, and Dk, respectively. More specifically, the developing devices Ky, Km, and Kc respectively accommodate yellow toner, magenta toner, and cyan toner for forming a visible image on a sheet S. The developing device Kk accommodates black toner (adhesive toner). The adhesive toner is used to form a user image (document image) and may also be used to heat-press a plurality of sheets S in the post-processing apparatus 130. Note that, by performing development using the adhesive toner, an adhesive image (adhesive layer) is formed on the photosensitive member drum Dk.

The image forming section 10 may also include a fifth process cartridge that uses toner dedicated to adhesion. Note that, in accordance with an intended usage of the image forming apparatus 100, the type of print toner (e.g., black or transparent) and the number of process cartridges 7 can be changed.

The charging rollers Cy, Cm, Cc, and Ck are chargers, and uniformly charge the surfaces of the corresponding photosensitive member drums Dy, Dm, Dc, and Dk, respectively. The exposure device 2 is disposed below the process cartridges 7y, 7m, 7c, and 7k and above the sheet cassette 8. The exposure device 2 irradiates the photosensitive member drums Dy, Dm, Dc, and Dk with corresponding laser beams Jy, Jm, Jc, and Jk, respectively, to form electrostatic latent images thereon. The exposure device 2 may also be referred to as an optical scanning device.

The developing devices Ky, Km, Kc, and Kk attach toner to the electrostatic latent images on the photosensitive member drums Dy, Dm, Dc, and Dk to form toner images, respectively. The developing devices Ky, Km, Kc, and Kk may also be referred to as developing devices.

The transfer unit 3 includes the transfer belt 30 as an intermediate transfer member (secondary image carrier). The transfer belt 30 is an endless belt wound around an inner roller 31 and a tension roller 32. The outer peripheral surface (image formation surface) of the transfer belt 30 faces the photosensitive member drums Dy, Dm, Dc, and Dk. On the inner peripheral side of the transfer belt 30, primary transfer rollers Fy, Fm, Fc, and Fk are disposed so as to face the respective photosensitive member drums Dy, Dm, Dc, and Dk.

The primary transfer rollers Fy, Fm, Fc, and Fk transfer the toner images from the corresponding photosensitive member drums Dy, Dm, Dc, and Dk to the transfer belt 30. The primary transfer rollers Fy, Fm, Fc, and Fk may also be referred to as primary transfer members. As the transfer belt 30 rotates counterclockwise, the toner image is conveyed to a secondary transfer section.

A secondary transfer roller 5 is disposed so as to face the inner roller 31, and a transfer nip 52 is formed between the secondary transfer roller 5 and the transfer belt 30. The transfer nip 52 transfers the toner image from the transfer belt 30 onto the sheet S. The transfer nip 52 may also be referred to as the secondary transfer section. A cleaning blade 71 is a cleaning member for removing toner remaining on the transfer belt 30. Toner scraped off by the cleaning blade 71 is accumulated in a collection container (not illustrated).

Above the secondary transfer roller 5 (downstream in the conveyance direction of the sheet S), a fixing device 6 is disposed. The fixing device 6 applies heat and pressure to the sheet S passing through a fixing nip 61. Accordingly, the toner image is fixed to the sheet S. Note that the fixing device 6 includes a fixing heater 62 for heating the toner image and the sheet S. The fixing heater 62 is, for example, a halogen heater, a ceramic heater, or the like.

As shown in FIG. 1, a switching guide 33 is a flap-shaped guide member provided downstream of the fixing device 6 in the conveyance direction of the sheet S. When a single-sided printing mode in which an image is formed on one side of the sheet S is selected, the switching guide 33 guides the sheet S to discharge rollers 34. When a double-sided printing mode in which images are formed on the two sides of the sheet S is selected, the switching guide 33 guides the sheet S, on which an image has been formed on a first side, to a pair of switchback rollers 35. The pair of switchback rollers 35 convey the sheet S in a predetermined direction. When the trailing edge of the sheet S becomes able to enter a double-sided printing conveyance path 36, the pair of switchback rollers 35 start reverse rotation. Accordingly, the sheet S is conveyed to the double-sided printing conveyance path 36. The double-sided printing conveyance path 36 conveys the sheet S to the secondary transfer section again. Accordingly, an image is formed on a second side of the sheet S.

The discharge rollers 34 convey the sheet S to the intermediate conveyance unit 120. The intermediate conveyance unit 120 includes a pair of conveyance rollers 121 and a pair of conveyance rollers 122. The pairs of conveyance rollers 121 and 122 convey the sheet S to the post-processing apparatus 130.

### Post-processing Apparatus

The post-processing apparatus 130 is a floor-standing sheet processing apparatus. The post-processing apparatus 130 includes a mechanism for buffering a plurality of sheets S, a mechanism for aligning the plurality of sheets S, and a mechanism for bonding (heat-pressing) a sheet bundle.

Hereinafter, an end portion of the sheet S on the front side in the conveyance direction is referred to as a leading edge. An end portion of the sheet S on the rear side in the conveyance direction is referred to as a trailing edge. Of the two end portions of the sheet S, the end portion that enters the post-processing apparatus 130 first is referred to as a first edge. Of the two end portions of the sheet S, the end portion that enters the post-processing apparatus 130 later is referred to as a second edge. Note that, due to switchback conveyance executed by the post-processing apparatus 130, the leading edge may be changed from the first edge to the second edge, and the trailing edge may be changed from the second edge to the first edge.

The sheet S conveyed from the intermediate conveyance unit 120 is delivered to inlet rollers 21 of the post-processing apparatus 130. A sheet sensor 27, which is referred to as an inlet sensor, is disposed downstream of the inlet rollers 21. When the sheet sensor 27 detects the trailing edge of the sheet S, a pair of conveyance rollers 22 accelerate the sheet S. When the trailing edge of the sheet S, whose discharge destination is set to an upper tray 25, reaches a position between the pair of conveyance rollers 22 and a pair of conveyance rollers 24, the pair of conveyance rollers 22 decelerates. Accordingly, the conveyance speed of the sheet S reaches a predetermined discharge speed. The pair of conveyance rollers 24 discharge the sheet S to the upper tray 25.

When the trailing edge of the sheet S, whose discharge destination is set to a lower tray 37, has passed a backflow prevention valve 23, the pair of conveyance rollers 24 stop conveying the sheet S. Thereafter, the pair of conveyance rollers 24 start reverse rotation. Accordingly, the sheet S is switched back and conveyed to a pair of conveyance rollers 26. When a sheet sensor 60 provided downstream of the pair of conveyance rollers 26 detects the leading edge of the sheet S, two rollers constituting the pair of conveyance rollers 24 move away from each other. Accordingly, the pair of conveyance rollers 24 become able to accept a subsequent sheet S. Furthermore, in a state where the pair of conveyance rollers 26 are nipping a preceding sheet S, the pair of conveyance rollers 26 stop. In synchronization with arrival of the subsequent sheet S, the pair of conveyance rollers 26 start reverse rotation. Accordingly, the subsequent sheet S is overlaid on the preceding sheet S. By repeatedly switching back a sheet S using the pair of conveyance rollers 26, a plurality of sheets S are overlaid to form a sheet bundle. Such an operation for forming a sheet bundle may also be referred to as a buffer operation. A unit that realizes the buffer operation is referred to as a buffer section 80. Note that formation of a sheet bundle is not essential in the buffer section 80. For example, the buffer section 80 may switch back a sheet S that has arrived from the image forming apparatus 100 and convey the sheet S to a stacking section 42. In this case, a sheet bundle is formed in the stacking section 42.

When a sheet bundle is completed in the buffer section 80, the pair of conveyance rollers 26 convey the sheet bundle toward the stacking section 42. The sheet bundle passes between a pair of conveyance rollers 28 and passes a sheet sensor 50. Furthermore, the sheet bundle is conveyed to the stacking section 42 by a pair of kick-out rollers 29. At the most downstream portion of the stacking section 42, a movable longitudinal aligning plate 39 is disposed at a standby position. When the sheet bundle abuts against the longitudinal aligning plate 39, the sheet bundle is aligned.

On the stacking section 42, a plurality of bundles of sheets are sequentially stacked. Note that a sheet bundle that is first conveyed to the stacking section 42 is referred to a first sheet bundle. The i-th sheet bundle that arrives at the stacking section 42 is referred to as an i-th sheet bundle. A sheet bundle that arrives last at the stacking section 42 is referred to as an N-th sheet bundle. Accordingly, a predetermined number of sheets S for forming a booklet are stacked on the stacking section 42. When alignment of the predetermined number of sheets S ends, a heat-press unit 51 executes a binding operation (heat-press processing), thereby forming a booklet. The heat-press processing may be executed each time a sheet bundle arrives at the stacking section 42. As the longitudinal aligning plate 39 moves from the standby position to a discharge position, the booklet is pushed toward a pair of discharge rollers 38. When a leading edge of the booklet is nipped between the pair of discharge rollers 38, the longitudinal aligning plate 39 stops and returns to the standby position. The pair of discharge rollers 38 discharge the booklet received from the longitudinal aligning plate 39 to the lower tray 37 through a discharge port 46.

In the following description, the post-processing apparatus 130 forms a sheet bundle composed of a plurality of sheets S using the buffer section 80, and conveys the sheet bundle to the stacking section 42. However, a single sheet S may be conveyed to the stacking section 42.

### Print Region for Adhesive Image Aim

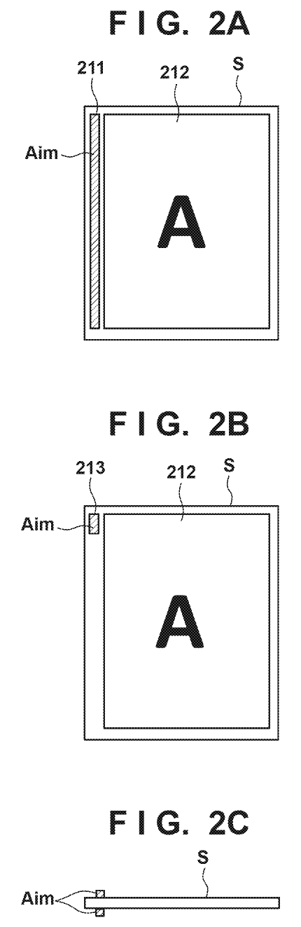

FIG. 2A shows a print region 211 of an adhesive image Aim. The print region 211 is an adhesive region secured in a binding margin of the sheet S. In this example, the print region 211 extends parallel to the long sides of the sheet S. The print region 211 is provided at a left end portion or a right end portion close to a long side. For a right-bound booklet, the print region 211 is disposed at the right edge of the sheet S. For a left-bound booklet, the print region 211 is disposed at the left edge of the sheet S. The print region 211 may be provided in an upper end portion or a lower end portion close to a short side of the sheet S. A plurality of sheets S are stacked in the post-processing apparatus 130, which executes heating processing and pressurizing processing on the print regions 211 of the plurality of sheets S, thereby bonding the plurality of sheets S together to form a booklet. The booklet in this case is a long-side-bound booklet. Here, the width (length in the short-side direction) of an adhesive toner image (the print region 211) is, for example, 4.0 mm. For example, a toner amount per unit area of the adhesive image Aim (coverage) may be 0.38 mg/cm². The print region 212 is a region in which a user image is printed.

As shown in FIG. 2B, a small print region 213 for the adhesive image Aim may be formed in the vicinity of a corner of each sheet S. Accordingly, a corner-bound booklet is formed. An image formed as the adhesive image Aim is not formed on the sheet S serving as the cover sheet of the booklet. For a right-bound booklet, the print region 213 is disposed on the upper right of the sheets S. For a left-bound booklet, the print region 213 is disposed on the upper left of the sheets S.

As shown in FIG. 2C, the print regions 211 and 213 for the adhesive image Aim may be respectively formed on the two sides of the sheet S, or the print region 211 or 213 may be formed on only one side of the sheet S. Whether the print regions 211 and 213 for the adhesive image Aim are respectively formed on the two sides or the print region 211 or 213 is formed on only one side may be selected in consideration of, for example, a bonding capability of the post-processing apparatus 130, a bonding capability of the adhesive image Aim, the type of sheets S, an intended usage of the booklet, and the like. For a booklet handled as an archival edition, reliable bonding performance is required. Reliable bonding performance is also required when thick paper or a special sheet S is used as a cover sheet of the booklet. Accordingly, in such cases, the print region 211 for the adhesive image Aim is provided on both sides of the sheet S. When a simple booklet for one-time use is produced, the print region 211 for the adhesive image Aim may be formed on only one side of the sheets S.

When the adhesive image Aim is formed on both sides of each sheet S, the adhesive image Aim formed on the front side of one sheet S and the adhesive image Aim formed on the back side of another sheet S come into contact with each other, and are bonded to each other. Note that the adhesive image Aim is formed on the back side of the front cover sheet of a booklet and on the front side of the back cover sheet, but is not formed on the front side of the front cover sheet or on the back side of the back cover sheet.

### Booklet Producing Operation

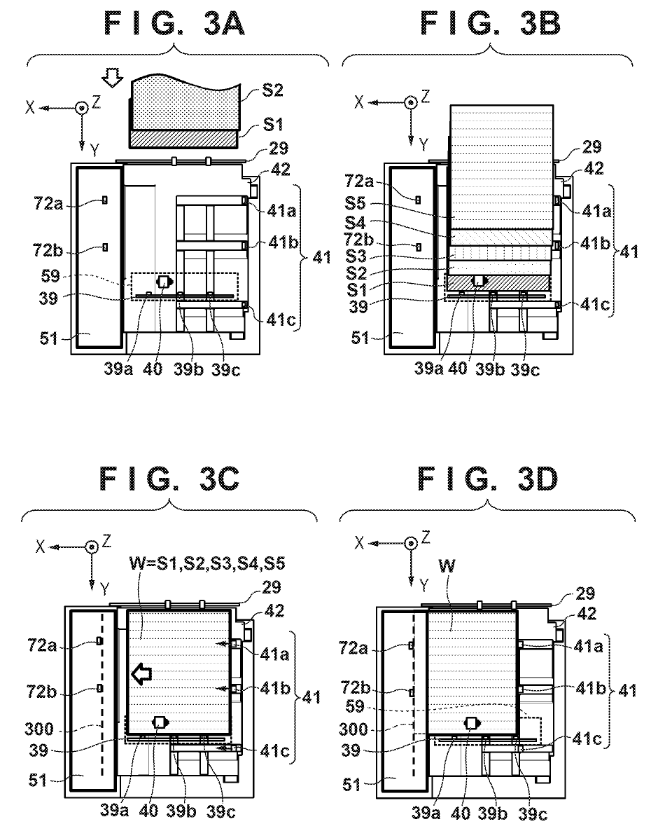

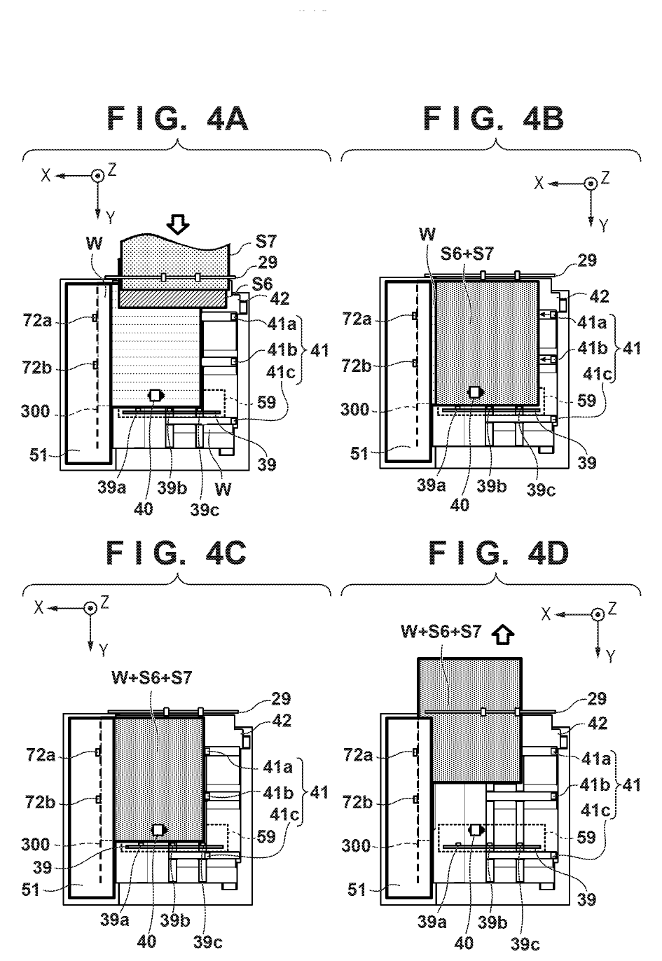

FIGS. 3A-3D and 4A-4D show a booklet producing operation that is executed in the stacking section 42. An initial state is a state where the stacking section 42 is empty. As an example, a sheet bundle W formed by five sheets S1 to S5 is conveyed from the buffer section 80 to the stacking section 42. The stacking section 42 functions as a support plate, a support member, or a holding member that supports the five sheets S1 to S5.

The Y direction is a direction parallel to a stacking surface (stacking plate) of the stacking section 42 on which the sheets S are stacked and parallel to the conveyance direction of the sheets S conveyed from the pair of kick-out rollers 29 to the stacking section 42. The Y direction may be referred to as a longitudinal direction. The X direction is a direction parallel to the stacking surface of the stacking section 42 on which the sheets S are stacked and orthogonal to the Y direction. The X direction may be referred to as a lateral direction. The Z direction is a direction orthogonal to both the X direction and the Y direction (the normal direction of the stacking surface and the thickness direction of the stacked sheets S). The Z direction may be referred to as a height direction. Directions opposite to the X direction, the Y direction, and the Z direction may be referred to as a −X direction, a −Y direction, and a −Z direction, respectively.

The longitudinal aligning plate 39 and the aligning roller 40 function as a first aligning unit that aligns a plurality of sheets S in a first direction (Y direction). The longitudinal aligning plate 39 is disposed at the most downstream portion of the stacking section 42 in the Y direction. The longitudinal aligning plate 39 serves as a reference member (first reference member) that defines a reference for a sheet position in the Y direction. The aligning roller 40 is a conveyance member for conveying the sheets S in the Y direction so as to cause the sheets S to abut against and align with the longitudinal aligning plate 39. The longitudinal aligning plate 39 includes a plurality of contact portions 39a to 39c arranged at intervals in the X direction. The contact portions 39a to 39c may also be referred to as longitudinal reference plates. The plurality of contact portions 39a to 39c come into contact with end portions (leading edge portions) of the sheets S. Accordingly, the position of the end portions in the longitudinal direction of the sheets S is aligned with a predetermined position. Note that the longitudinal aligning plate 39 and the aligning roller 40 are integrally configured as a movable unit 59 that is movable in the Y direction. The movable unit 59 is movable in the Y direction due to a driving source such as a motor. For example, the positions of the longitudinal aligning plate 39 and the aligning roller 40 in the Y direction can be adjusted in accordance with the size of the sheets S or the position of the adhesive images Aim. Lateral aligning plates 41a to 41c of a lateral alignment jogger 41 function as an aligning unit that aligns the sheets S in the X direction orthogonal to the Y direction.

The lateral aligning plates 41a to 41c move in the X direction by a driving source such as a motor, and press the side edges (right sides) of the sheets S stacked on the stacking section 42. Lateral reference plates 72a and 72b are reference members that define a reference for the position of the sheets S in the X direction. As the side edges (left side) of the sheets S abut against the lateral reference plates 72a and 72b, the position in the X direction (lateral direction) of the side edges of the sheets S is aligned to a predetermined position. The lateral reference plates 72a and 72b are disposed so as to face lateral aligning plates 41a and 41b in the X direction, respectively.

### Preparation Stage

As shown in FIG. 3A, the sheets S1 to S5 are conveyed toward the pair of kick-out rollers 29. The sheets S1 to S5 may be conveyed to the stacking section 42 in a state where a lower-positioned sheet Sj protrudes in the Y direction beyond an upper-positioned sheet Sj+1. Here, j is an index of a sheet S. Before the sheets S are stacked on the stacking section 42, the longitudinal aligning plate 39 moves in advance to a predetermined standby position in accordance with the size of the sheets S to be aligned. The standby position is set such that the position of the end portions in the −Y direction of the sheets S reaches a predetermined position, independent of the size of the sheets S. In other words, the standby position is a position that is set such that the distance in the Y direction from a nip position of the pair of kick-out rollers 29 to the longitudinal aligning plate 39 is slightly longer than the length in the Y direction of the sheets S. The lateral aligning plates 41a to 41c wait at standby positions that are spaced outward in the X direction from the sheets S that are being conveyed, so as not to interfere with conveyance of the sheets S.

### Longitudinal Alignment Stage

FIG. 3B indicates that the trailing edge of a first sheet S1 has passed through a nip of the pair of kick-out rollers 29, and the leading edge of the sheet S1 has reached the aligning roller 40. The sheet S1 is abutted against the longitudinal aligning plate 39, and is aligned based on the position of the longitudinal aligning plate 39. As the aligning roller 40 continues to rotate, the sheets S2 to S5 that reach the aligning roller 40 subsequent to the sheet S1 are sequentially abutted against the longitudinal aligning plate 39. Accordingly, the five sheets S1 to S5 are aligned in the Y direction (longitudinal direction) based on the position of the longitudinal aligning plate 39.

### Lateral Alignment Stage

FIG. 3C indicates that, after alignment in the Y direction (longitudinal direction) of the sheets S1 to S5 was completed, alignment in the X direction (lateral direction) has been started. The lateral aligning plates 41a to 41c are driven in the X direction, which is an alignment direction, abut against the side edge of the sheets S1 to S5, and press the sheets S1 to S5 toward the lateral reference plates 72a and 72b. Then, as the opposite side edges of the sheets S1 to S5 abut against contact surfaces 300 of the lateral reference plates 72a and 72b, the sheets S1 to S5 are aligned in the X direction (lateral direction) based on the positions of the lateral reference plates 72a and 72b.

### Bonding Stage (Heat-pressing Stage)

FIG. 3D shows a state where alignment of the five sheets S1 to S5 in the X direction and the Y direction is complete. A target position (alignment position) in an alignment operation is the position of the sheet bundle W when bonding processing is performed by the heat-press unit 51. As described above, the image forming apparatus 100 forms the adhesive image Aim on the sheets S1 to S5 such that, of two sides of each sheet S, a side (left side) on which the adhesive image Aim has been formed is disposed on the heat-press unit 51 side. When the sheet S1 is the front cover of a booklet, the adhesive image Aim may not be formed thereon.

The heat-press unit 51 applies heat-pressing to the sheets S1 to S5 that have been aligned. During this time, the lateral aligning plates 41a to 41c move in the −X direction and return to the standby positions. Accordingly, the stacking section 42 becomes able to accept the next one or more sheets S. Thereafter, a sheet bundle W formed by sheets S6 to S10 and generated in the buffer section 80 is stacked on the sheets S1 to S5. However, there are cases where, when a booklet is formed of a plurality of bundles of sheets W, the number of sheets S included in the last sheet bundle W is smaller than a predetermined number of sheets (e.g., five sheets). Therefore, there are also cases where the last sheet bundle W includes only the sheets S6 and S7 as shown in FIG. 4A. In the following description, it is assumed that the sheet bundle W is formed of the sheets S6 and S7.

As shown in FIG. 4B, the longitudinal alignment stage is executed on the preceding sheet bundle W formed by the sheets S1 to S5 bonded together and the sheet bundle W formed by the sheets S6 and S7 that have not been bonded together. As shown in FIG. 4C, the lateral alignment stage and the bonding stage are executed on the preceding sheet bundle W and the sheets S6 and S7 that have not been bonded together. Accordingly, the sheets S1 to S7 are bonded together in an accurately aligned state. When a booklet is completed, as shown in FIG. 4D, the booklet is pushed out in the −Y direction by the longitudinal aligning plate 39, and is further conveyed in the discharge direction by the pair of kick-out rollers 29. The pair of discharge rollers 38 discharge the booklet to the lower tray 37.

Here, as an example, the sheet bundle W consists of five sheets S. However, the number of sheets S constituting the sheet bundle W may be two, three, or the like. That is to say, it suffices for the number of sheets S included in the sheet bundle W to be no greater than the maximum number of sheets S that can be overlaid on the buffer section 80. Alternatively, the sheet bundle W may be formed not in the buffer section 80 but in the stacking section 42. In this case, the sheets S are conveyed one by one to the stacking section 42, and when the number of sheets S stacked on the stacking section 42 reaches a predetermined number, the lateral alignment stage and the bonding stage are executed.

### Heat-press Unit

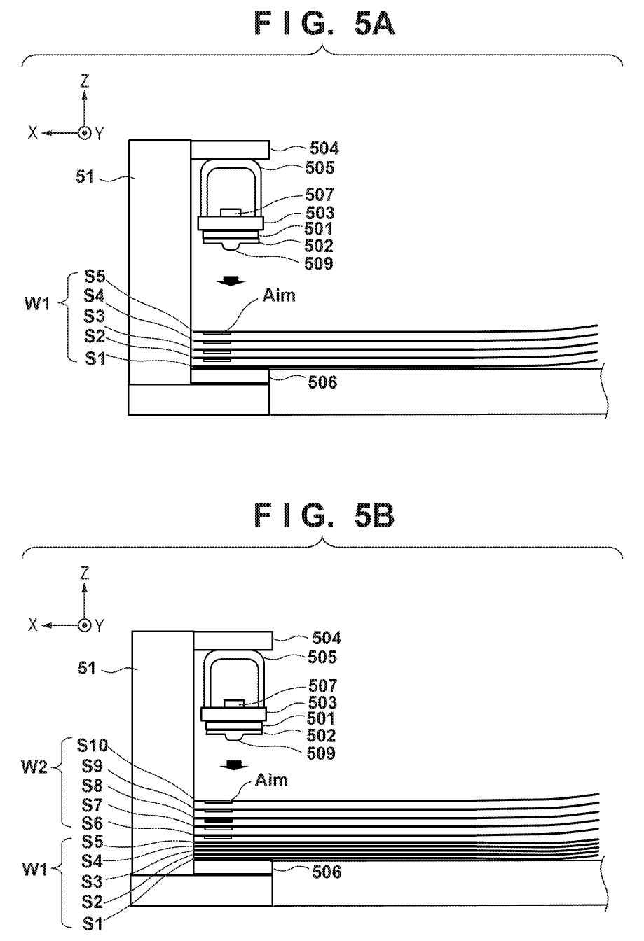

As shown in FIG. 5A, the heat-press unit 51 includes a heater 501 in which a heat-generating element is incorporated as a heating source, and an aluminum heating plate 502 disposed on the heater 501. The surface of the heating plate 502 may be coated to improve releasability with respect to toner. The coating material is, for example, a copolymer of tetrafluoroethylene and perfluoroalkoxy ethylene (PFA). The length (thickness) in the Z direction of the heater 501 is, for example, 1.0 mm. The length (width) in the X direction of the heater 501 is, for example, 8.0 mm. The length in the Y direction of the heater 501 is, for example, 350 mm. The thickness of the heating plate 502 is, for example, 1.5 mm. The heater 501 is, for example, a ceramic heater. The temperature of the heater 501 may be measured by a temperature sensor 507, and be controlled by a control circuit such that the measured temperature reaches a target temperature. For example, the target temperature (e.g., 240° C) is set such that the surface temperature of a pressurizing section 509 of the heating plate 502 reaches 200° C. By providing the pressurizing section 509 on the heating plate 502, heat and pressure from the heat-press unit 51 are concentrated at a binding position of the sheet bundle W. As a result, heating efficiency and pressing efficiency are improved. The elastic modulus of the pressurizing section 509 is at least 1000 Pa or more, but may be 10000 Pa or more. Accordingly, even when heat-pressing is repeatedly executed, the pressurizing section 509 is less likely to deform.

The heater 501 is supported by a resin support 503. A pressurizing lever 504 receives motive power from a motor (not illustrated) to press the heat-press unit 51 in the −Z direction (downward), thereby pressurizing the sheet bundle W. A pressurizing force of the pressurizing lever 504 is transmitted to the pressurizing section 509 via a metal stay 505 serving as a rigid body. The pressurizing force of the pressurizing lever 504 is controllable in accordance with an amount of movement of the pressurizing lever 504 in the −Z direction (downward). Average surface pressure acting on the sheet bundle W is, for example, 0.2 MPa. A heat-press time T1 is, for example, 2.0 seconds. The heat-press time may also be referred to as a contact time, a pressurizing time, or a heating time.

A pressurizing plate 506 is a receiving member formed of an elastic material (e.g., silicone rubber). A reason for adopting an elastic material is that the pressurizing plate 506 is a member configured to stably receive a pressurizing force. The elastic modulus of the pressurizing plate 506 is, for example, 1000 Pa or less. The pressurizing plate 506 may also be provided with a PFA coating. The thickness of the pressurizing plate 506 is, for example, 2.0 mm. The heat-press unit 51 pressurizes a sheet bundle W1 formed by the sheets S1 to S5, and then moves away from the sheet bundle W1. The sheets S1 to S5 in FIG. 5A correspond to first to fifth sheets S1 to S5 of a booklet that is a product. The sheet S1 is the front cover of the booklet. Therefore, the adhesive image Aim is not formed on the lower surface of the sheet S1, and is formed only on the upper surface. The adhesive image Aim is formed on the upper and lower surfaces of each of the sheets S2 to S5, which are second and subsequent sheets of the booklet.

As shown in FIG. 5B, a sheet bundle W2 is stacked on the sheets S1 to S5 that have undergone heat-pressing. The sheet bundle W2 consists of sheets S6 to S10. The heat-press unit 51 applies a heat-press operation to the sheet bundle W2 stacked on the sheet bundle W1. Accordingly, a booklet constituted by a large number of sheets S is produced. Note that the number of sheets constituting the sheet bundle W1 may be different from the number of sheets constituting the sheet bundle W2.

The sheets S6 to S10 that are stacked later are to be included in the same booklet as the sheets S1 to S5. Therefore, the adhesive image Aim is formed on the upper and lower surfaces of each of the sheets S6 to S10.

As an example, the post-processing apparatus 130 is capable of producing a booklet formed by up to 100 sheets S. When production of a booklet starts, the buffer section 80 buffers up to five sheets S at a time to form a sheet bundle W, and supplies the sheet bundle W to the stacking section 42. Each time a sheet bundle W arrives, the heat-press unit 51 performs the heat-press operation including a descending operation, a pressurizing operation, and an ascending operation. By repeating the buffering operation and the heat-press operation, a booklet is efficiently produced without decreasing the productivity of the image forming apparatus 100.

When the heat-press operation on the sheet bundle W including the last page of the booklet is completed on the stacking section 42, the longitudinal aligning plate 39 moves from the standby position to the discharge position. That is to say, as the longitudinal aligning plate 39 translates toward the discharge port 46, the completed booklet is pushed out. The pair of discharge rollers 38 are provided at the discharge port 46. When the leading edge of the booklet has passed slightly beyond the pair of discharge rollers 38, the longitudinal aligning plate 39 stops and returns to the standby position. The pair of discharge rollers 38 discharge the booklet to the lower tray 37.

### Curl of Sheets S

As shown in FIGS. 5A and 5B, the sheets S that have passed through the fixing device 6 may be curled. The curl of the sheets S depends on the material and the use environment of the sheet S. For example, in a high-temperature and high-humidity environment, the sheets S absorb a large amount of moisture. When the sheets S are heated by the fixing device 6, the moisture evaporates, causing the sheets S to be curled. When curl of a preceding sheet S is small, the curl is less likely to affect conveyance and alignment of a subsequent sheet S. In this case, the subsequent sheet S can be accepted on the stacking section 42 while a preceding sheet bundle W is being bonded. When curl of a preceding sheet S is large, there is the possibility that the curl will affect conveyance, stacking, and alignment of a subsequent sheet S.

Here, a case is considered in which end portions of sheets S curl in the +Z direction about the Y direction serving as an axis. When two end portions of each of the sheets S included in a preceding sheet bundle W are curled in the +Z direction, and the end portion on the +X side (in the vicinity of the left side) of the preceding sheet bundle W is pressurized by the heat-press unit 51, the end portion on the −X side (in the vicinity of the right side) that has not been pressurized is lifted in the +Z direction. In a state where the one end portion of the sheet bundle W is lifted in the +Z direction, a subsequent sheet S is conveyed to the stacking section 42. The subsequent sheet S is conveyed while being in contact with the end portion of the preceding sheet S lifted in the +Z direction. This may hinder conveyability and stackability. Furthermore, in a state of being lifted by the preceding sheets S, the subsequent sheet S abuts against the longitudinal aligning plate 39. Since the circumferential surface of the aligning roller 40 obliquely comes into contact with the surface of the subsequent sheet S, the alignment accuracy in the Y direction of the subsequent sheet S also decreases. Conveyability, stackability, and alignment accuracy may also be collectively referred to as post-processing performance or post-processing quality.

### Switching between Parallel Mode and Non-parallel Mode

As shown in FIGS. 4A and 4B, conveyance, stacking, and alignment of a subsequent sheet S to and on the stacking section 42 during a period in which the bonding processing is being executed on a preceding sheet bundle W is referred to as a parallel operation or a parallel mode. Conveyance, stacking, and alignment of a subsequent sheet S to and on the stacking section 42 after completion of the bonding processing on a preceding sheet bundle W is referred to as a non-parallel operation or a non-parallel mode. The parallel mode provides high booklet production efficiency per unit time. The non-parallel mode is advantageous in terms of post-processing performance in booklet production. In the present embodiment, when a condition related to a preceding sheet S or a subsequent sheet S satisfies a predetermined condition (condition that causes post-processing performance to decrease), the booklet production mode is switched from the parallel mode to the non-parallel mode. Here, since the predetermined condition is a condition for switching from the parallel mode to the non-parallel mode, the predetermined condition is referred to as a non-parallel condition (mode switching condition).

The non-parallel condition includes, for example, one or more of a type of sheets S (e.g., a basis weight, a thickness, a material, a coating, surface treatment, or surface properties), an environmental condition (e.g., temperature and humidity), the number of sheets S to be stacked on the stacking section 42, the size of sheets S, and the like.

For example, when the type of sheets S is a type prone to curling, the post-processing apparatus 130 selects the non-parallel mode. When the type of sheets S is a type that is less prone to curling, the post-processing apparatus 130 selects the parallel mode. In the non-parallel mode, when the bonding processing on a preceding sheet bundle W1 is completed and the pressurizing lever 504 returns to a non-pressurizing position (standby position), conveyance, stacking, and alignment of a subsequent sheet bundle W2 are executed.

### Controller

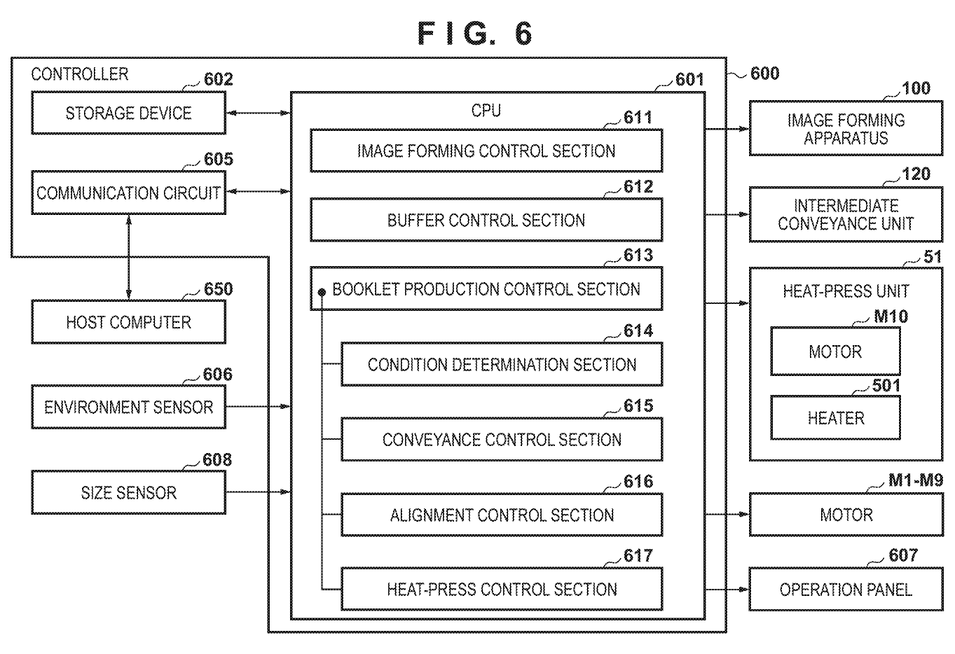

FIG. 6 shows a controller 600 of the image forming system 1. The controller 600 includes a central processing unit (CPU) 601, a storage device 602, and a communication circuit 605. The CPU 601 realizes a plurality of functions in accordance with control programs stored in the storage device 602. The CPU 601 is described as representing one or more CPUs. Some or all of the functions described below may be implemented in another integrated circuit (for example, an application-specific integrated circuit (ASIC)) that is communicable with the CPU 601. The storage device 602 is a combination of a volatile memory and a non-volatile memory, such as a read-only memory (ROM), a random-access memory (RAM), and a solid-state drive (SSD). The communication circuit 605 receives, from a host computer 650, job information for booklet production. The job information includes information indicating the type, the number, the length, the binding position, and the like of sheets S to be included in a booklet. Such information may also be input via an operation panel 607.

An image forming control section 611 controls the image forming apparatus 100 based on job information, and forms a user image and the adhesive image Aim on sheets S. A buffer control section 612 controls processing for producing a sheet bundle W in the buffer section 80. A booklet production control section 613 controls the post-processing apparatus 130 with respect to booklet production. The booklet production control section 613 includes a condition determination section 614, a conveyance control section 615, an alignment control section 616, and a heat-press control section 617. The condition determination section 614 determines whether or not the sheets S satisfy the non-parallel condition based on job information, input information from the operation panel 607, detection information from an environment sensor 606, detection information from a size sensor 608, and the like. The environment sensor 606 detects an environmental temperature and an environmental humidity in an installation environment in which the post-processing apparatus 130 or the sheets S are placed. The size sensor 608 detects the size of the sheets S accommodated in the sheet cassette 8. The non-parallel condition is a condition related to switching between the parallel mode and the non-parallel mode. The conveyance control section 615 controls conveyance of the sheets S in the image forming apparatus 100, the intermediate conveyance unit 120, and the post-processing apparatus 130. For example, the conveyance control section 615 controls motors M1 to M6. The motor M1 rotationally drives the inlet rollers 21. The motor M2 rotationally drives the pair of conveyance rollers 22. The motor M3 rotationally drives the pair of conveyance rollers 24. The motor M4 rotationally drives the pair of conveyance rollers 26. Note that the buffer control section 612 controls the motors M1 to M4 through the conveyance control section 615 such that a sheet bundle is formed in the buffer section 80. The motor M5 rotationally drives the pair of conveyance rollers 28 and the pair of kick-out rollers 29. The motor M6 rotationally drives the pair of discharge rollers 38. The alignment control section 616 drives motors M7 to M9 involved in longitudinal alignment and lateral alignment. The motor M7 rotationally drives the aligning roller 40. The motor M8 moves the movable unit 59 in the +Y direction or the −Y direction. Accordingly, the movable unit 59 is disposed at an appropriate position (alignment position) corresponding to the length in the Y direction of the sheets S, or pushes out a completed booklet in the −Y direction. The motor M9 moves the lateral aligning plates 41 in the +X direction or the −X direction. Accordingly, the lateral aligning plates 41 each move between the alignment position and the standby position. The heat-press control section 617 controls a motor M10 and the heater 501 of the heat-press unit 51. The motor M10 moves the pressurizing lever 504 in the +Z direction or the −Z direction. Accordingly, the pressurizing lever 504 moves between a pressurizing position and the standby position.

### 9. Flowchart

### High-level Concept

FIG. 7 is a flowchart showing a method for switching operation modes. A default operation mode is the parallel mode.

In step S701, the CPU 601 (the condition determination section 614) obtains determination information required for determination of the non-parallel condition, such as type information of sheets S. The condition determination section 614 analyzes job information to extract determination information, accepts determination information input through the operation panel 607, and obtains environmental information from the environment sensor 606.

In step S702, the CPU 601 (the condition determination section 614) determines whether or not the non-parallel condition is satisfied, based on the determination information. Representative examples of the non-parallel condition are as follows.

the type of sheets S is a type that is prone to curling

the environmental condition is a condition according to which the sheets S are likely to curl

the number N of sheets S to be included in a booklet exceeds a threshold number Nth of sheets

the length L in the conveyance direction of the sheets S exceeds a predetermined length Lth

The non-parallel condition may be one, two, three, or four of these conditions. In addition, the non-parallel condition may be that one of a plurality of sub-conditions is satisfied, or all of the plurality of sub-conditions are satisfied. The non-parallel condition may be that M sub-conditions out of N sub-conditions are satisfied (M is an integer greater than or equal to 1 and less than or equal to N−1).

The type information of sheets S may be brand information of the sheets S or physical parameters representing the characteristics of the sheets S. The type information includes a basis weight and a thickness. The smaller the basis weight is, the more likely the sheets S are to curl. The smaller the thickness is, the more likely the sheets S are to curl. In particular, thin sheets are susceptible to the environmental humidity and temperature, and thus, thin sheets that have passed through the fixing device 6 are likely to curl. Thus, the non-parallel mode is applied to thin sheets, and the parallel mode is applied to plain sheets and thick sheets.

The type information may indicate the material of the sheets S. Recycled paper is more likely to be affected by humidity and temperature than new paper. Therefore, recycled paper that has passed through the fixing device 6 is more likely to curl than new paper. Thus, the non-parallel mode is applied to recycled paper, while the parallel mode is applied to new paper.

The type information may indicate treatment applied to the sheets S or surface properties of the sheets S. Here, the treatment refers to coating applied to surfaces of the sheets S, surface treatment (e.g., embossing), or the like. The surface properties refer to surface smoothness of the sheets S or the like. When the sheets S to which surface treatment was applied have passed through the fixing device 6, the sheets S are more likely to curl, although it depends on a type of surface treatment. Thus, the non-parallel mode is applied to sheets S to which surface treatment was applied, while the parallel mode is applied to sheets S to which surface treatment has not been applied.

One example of the environmental condition is that the environmental temperature is 30° C or higher and the environmental humidity is 80% or higher. Note that the environmental condition may also be that the environmental temperature is 30° C or higher. Similarly, the environmental condition may also be that the environmental humidity is 80% or higher. Note that these numerical values are merely examples. When the environmental temperature is 30° C or higher and the environmental humidity is 80% or higher, the non-parallel mode is applied. When the environmental temperature is lower than 30° C, the parallel mode is applied. When the environmental humidity is lower than 80%, the parallel mode is applied.

As the number N of sheets S forming a preceding sheet bundle W stacked on the stacking section 42 increases, the height of curl in the +Z direction increases. This increases an angle formed between a subsequent sheet S and an XY plane (the stacking surface of the stacking section 42), thereby decreasing post-processing performance of the subsequent sheet S. Thus, when the number N of sheets S forming the preceding sheet bundle W exceeds a threshold Nth (e.g., 30 sheets), the non-parallel mode may be appropriate. When the number N of sheets S is smaller than or equal to the threshold Nth, the parallel mode may be appropriate.

When the size of the sheets S is large and the binding technique is corner binding, it is difficult for the movable unit 59 to accept a subsequent sheet S during the bonding processing of a preceding sheet bundle W. Thus, also in this case, the non-parallel mode is suitable. Specifically, when the length in the Y direction of the sheets S or the length in the Y direction of the adhesive images Aim formed on the sheets S exceeds the length of a heat-press region of the heat-press unit 51, the non-parallel mode is required.

When the non-parallel condition is satisfied, the CPU 601 advances the procedure from S702 to S703. In S703, the CPU 601 applies the non-parallel mode to the subsequent sheet S (sheet bundle W). Specifically, after the bonding processing performed on the preceding sheet bundle W is completed, the subsequent sheet S is conveyed to the stacking section 42, stacked on the preceding sheet bundle W, and aligned.

When the non-parallel condition is not satisfied, the CPU 601 advances the procedure from S702 to S710. In S710, the CPU 601 applies the parallel mode to the subsequent sheet S (the sheet bundle W). Specifically, during the bonding processing of the preceding sheet bundle W, the subsequent sheet S is conveyed to the stacking section 42, stacked on the preceding sheet bundle W, and aligned in the longitudinal direction. Note that, during the bonding processing of the preceding sheet bundle W, lateral alignment processing cannot be executed.

According to the present embodiment, the non-parallel mode and the parallel mode are switched in accordance with whether or not the sheets S for forming a booklet satisfy the non-parallel condition. Accordingly, both post-processing performance of the sheet bundle W and booklet productivity are achieved. For example, even when sheets S prone to curling are used, errors in booklet production are less likely to occur. On the other hand, when sheets S that are unlikely to curl are used, relatively high booklet productivity is realized.

### Mode Switching Based on Type

Various sub-conditions that may constitute the non-parallel condition have already been listed. Here, an example of a combination of the above plurality of sub-conditions will be described. Only a type of sheets S is adopted as the non-parallel condition.

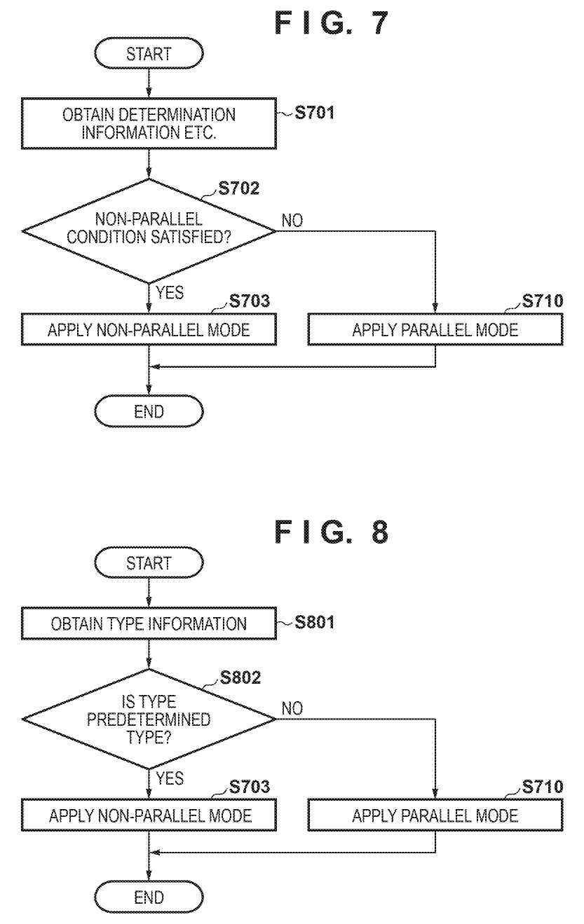

FIG. 8 shows a method for switching operation modes in accordance with a type of sheets S. In this example, determination information includes only a type of sheets S.

In S801, the CPU 601 (the condition determination section 614) obtains type information of a preceding sheet S. The type information is obtained from job information or input information from the operation panel 607.

In S802, the CPU 601 determines whether or not the type of sheets S is a predetermined type. The predetermined type may be thin paper. The predetermined type may be sheets S having a basis weight less than or equal to a threshold. The predetermined type may be a predetermined material (e.g., recycled paper). The predetermined type may be predetermined surface treatment.

When the type of sheets S is a predetermined type, the CPU 601 advances the procedure from S802 to S703, and applies the non-parallel mode. When the type of sheet S is not a predetermined type, the CPU 601 advances the procedure from S802 to S710, and applies the parallel mode.

### Example of Combination of Plurality of Sub-conditions

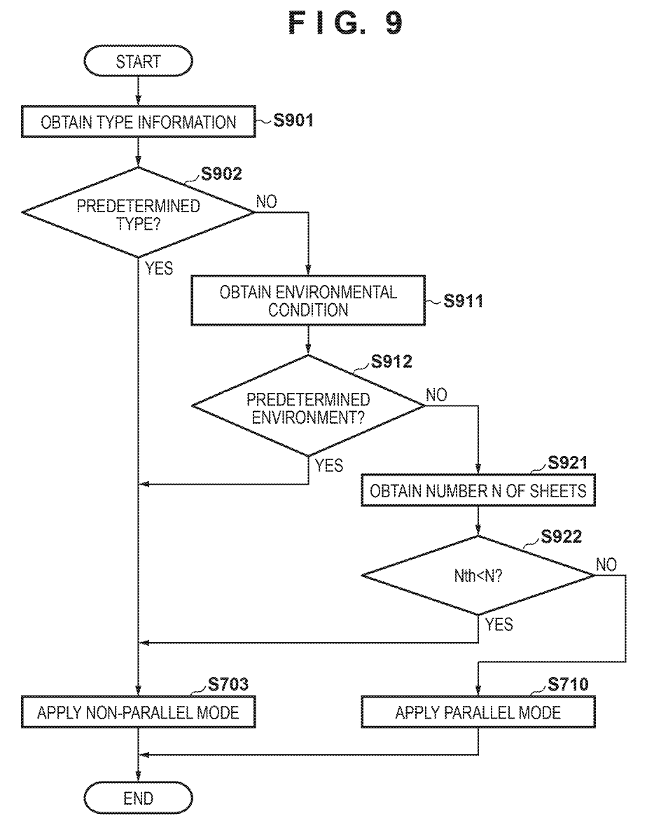

Here, a plurality of sub-conditions, including a type of sheet S, environmental conditions, and the number of sheets S, are adopted as examples. Furthermore, the non-parallel condition is that any one of the plurality of sub-conditions is satisfied. FIG. 9 is a flowchart showing a method for switching modes in consideration of the non-parallel condition composed of a combination of a plurality of sub-conditions.

In S901, the CPU 601 (the condition determination section 614) obtains type information from job information or input information from the operation panel 607. In S902, the CPU 601 (the condition determination section 614) determines whether or not the type of sheets S indicated by the type information of the sheets S is a predetermined type. If the type of sheets S is the predetermined type, the CPU 601 advances the procedure from S902 to S703, and applies the non-parallel mode. On the other hand, if the type of sheets S is not the predetermined type, the CPU 601 advances the procedure from S902 to S911.

In S911, the CPU 601 (the condition determination section 614) obtains an environmental condition using the environment sensor 606. In S912, the CPU 601 (the condition determination section 614) determines, based on the environmental condition, whether or not an installation environment where the heat-press unit 51 or the sheet bundle W is placed is a predetermined environment. The predetermined environment is, for example, an environment in which the environmental temperature is 30° C or higher and the environmental humidity is 80% or higher. If the installation environment is the predetermined environment, the CPU 601 (the condition determination section 614) advances the procedure from S912 to S703, and applies the non-parallel mode. On the other hand, if the installation environment is not the predetermined environment, the CPU 601 advances the procedure from S912 to S921.

In S921, the CPU 601 (the condition determination section 614) obtains the number N of sheets from the job information. The number N of sheets refers to the total number of sheets S that form a booklet designated by the job information. Note that this may also be the total number of preceding sheets S stacked on the stacking section 42.

In S922, the CPU 601 (the condition determination section 614) determines whether or not the number N of sheets exceeds a threshold number Nth of sheets. If the number N of sheets exceeds the threshold number Nth of sheets, the CPU 601 advances the procedure from S922 to S703, and applies the non-parallel mode. On the other hand, if the number N of sheets does not exceed the threshold number Nth of sheets, the CPU 601 advances the procedure from S922 to S710, and applies the parallel mode.

The curl of each sheet S may increase depending on ambient temperature and humidity. Even when the curl of each sheet S is small, the curl of a sheet bundle W may increase depending on the number N of sheets forming a booklet or the sheet bundle W. When the curl of each sheet S becomes large, there is the possibility that post-processing performance of a subsequent sheet S will be decreased.

Therefore, the non-parallel mode and the parallel mode may be switched based on a type of sheets S, an environmental condition, and the number N of sheets S. Accordingly, it may be possible to suppress a decrease in booklet productivity while suppressing a decrease in post-processing performance of the subsequent sheet S. In particular, since errors in booklet production caused by a decrease in post-processing performance are reduced, wasteful consumption of resources such as paper and toner may be suppressed.

### Mode Switching Based on Sheet Size

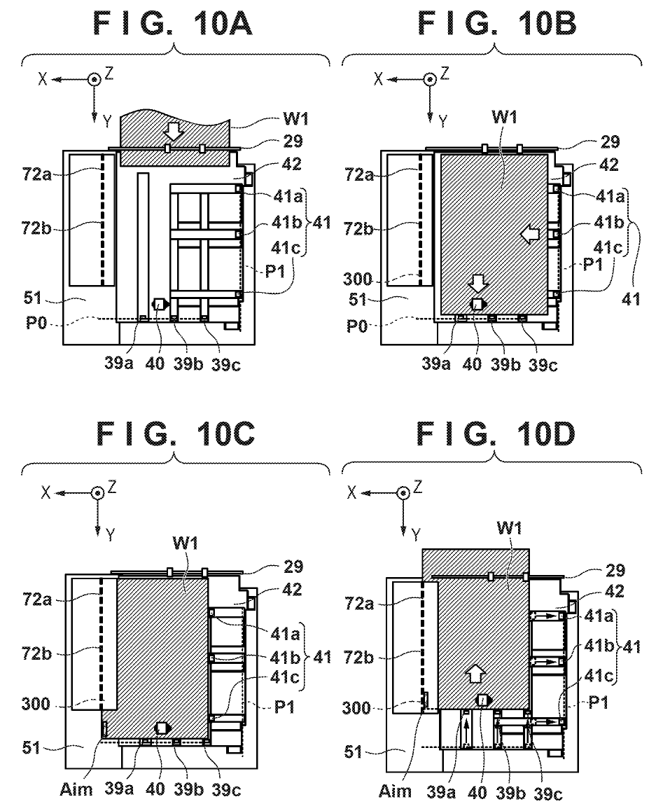

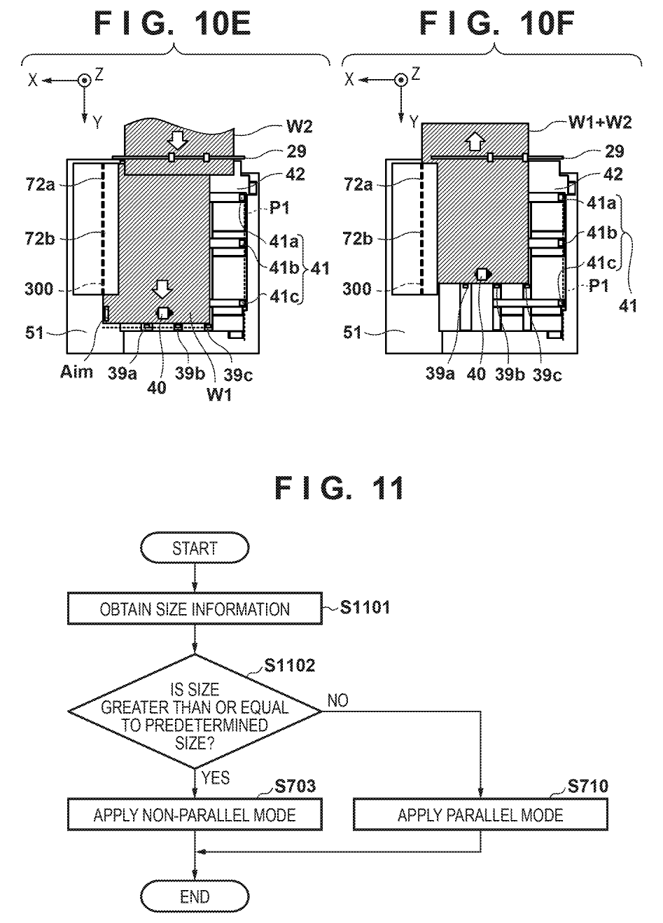

As described above, the parallel mode and the non-parallel mode may be switched depending on the size of sheets S that are conveyed to the stacking section 42. FIGS. 10A-10F show a method for producing a booklet using sheets S having a larger size than a predetermined size. Here, it is assumed that the size of the sheets S is the leagal (LGL) size (355.6 mm in length × 215.9 mm in width). The CPU 601 can specify the size of the sheets S based on a detection result of the size sensor 608, size information input through the operation panel 607, or size information specified by job information.

As described above, there are cases where the parallel mode cannot be executed depending on the size of sheets S. If the longitudinal aligning plate 39 is not at a position for accepting the sheets S (standby position) when the heat-press unit 51 bonds the sheet bundle W, the stacking section 42 cannot accept a subsequent sheet S. Thus, when the size of the sheets S is larger than the predetermined size, the non-parallel mode is selected.

In FIG. 10A, the longitudinal aligning plate 39 is positioned at a standby position P0, and the lateral alignment jogger 41 is positioned at a standby position P1. In this standby state, a preceding sheet bundle W1 formed by one or more LGL-sized sheets S is conveyed to the stacking section 42.

As shown in FIG. 10B, the aligning roller 40 conveys the sheet bundle W1 toward the longitudinal aligning plate 39 at a predetermined timing. The aligning roller 40 causes the leading edge of the sheet bundle W1 to abut against the longitudinal aligning plate 39. Accordingly, longitudinal alignment is completed. As shown in FIGS. 10B and 10C, by moving from standby positions to contact positions, the lateral aligning plates 41a to 41c move the sheet bundle W1 in the +X direction. Accordingly, the side end portion of the sheet bundle W1 abuts against the lateral reference plates 72a and 72b, thereby realizing lateral alignment. As described above, the sheet bundle W1 may be formed on the stacking section 42. In this case, longitudinal alignment and lateral alignment are executed each time one sheet S reaches the stacking section 42.

As shown in FIG. 10C, the adhesive image Aim for corner binding is formed on the sheet bundle W1. The adhesive image Aim is not disposed at a position where the heat-press unit 51 can perform heat-pressing. Therefore, the longitudinal aligning plate 39 moves from the standby position P0 in the -Y direction so as to move the sheet bundle W1. Accordingly, the adhesive image Aim formed on the sheet bundle W1 is disposed at the position where the heat-press unit 51 can perform heat-pressing. In parallel with this, the lateral aligning plates 41a to 41c return to the standby position P1. The heat-press unit 51 executes the bonding processing on the sheet bundle W1.

As shown in FIG. 10D, the longitudinal aligning plate 39 is positioned at a bonding position separated from the standby position P0 and supports the sheet bundle W1 during the bonding processing. Therefore, the stacking section 42 cannot accept a subsequent sheet bundle W2. If the stacking section 42 accepts the subsequent sheet bundle W2, there is the possibility that, when the leading edge of the subsequent sheet bundle W2 comes into contact with the longitudinal aligning plate 39, the subsequent sheet bundle W2 will be deformed in the vicinity of the trailing edge portion thereof due to the pair of kick-out rollers 29. This may decrease the post-processing performance of the subsequent sheet bundle W2. Therefore, when the size of the sheets S is larger than or equal to the predetermined size, the non-parallel mode is selected, and the parallel mode is not selected.

Upon completion of the bonding processing on the preceding sheet bundle W1, the pressurizing lever 504 is raised from a bonding position to a standby position. Furthermore, as shown in FIG. 10E, the longitudinal aligning plate 39 returns to the standby position P0 from the bonding position. The sheet bundle W1 also returns to the standby position P0 in conjunction with the longitudinal aligning plate 39. Accordingly, the stacking section 42 can accept the subsequent sheet bundle W2. The subsequent sheet bundle W2 also consists of one or more sheets S.

The subsequent sheet bundle W2 is conveyed in the +Y direction while sliding over the preceding sheet bundle W1. Furthermore, the subsequent sheet bundle W2 is further conveyed in the +Y direction by the aligning roller 40, and the leading edge of the subsequent sheet bundle W2 abuts against the longitudinal aligning plate 39. Accordingly, longitudinal alignment of the preceding sheet bundle W1 and the subsequent sheet bundle W2 is completed. Thereafter, lateral alignment of the subsequent sheet bundle W2 is executed using the lateral aligning plates 41a to 41c, thereby completing lateral alignment of the preceding sheet bundle W1 and the subsequent sheet bundle W2. The bonding processing is then executed on the subsequent sheet bundle W2 stacked on the preceding sheet bundle W1.

When a booklet composed of the sheet bundle W1 and the sheet bundle W2 is completed, the booklet is moved in the -Y direction by the longitudinal aligning plate 39 and the pair of kick-out rollers 29 as shown in FIG. 10F. The booklet is discharged to the lower tray 37. In this manner, when the size of the sheets S is larger than or equal to the predetermined size, the non-parallel mode is applied. When the size of the sheets S is smaller than the predetermined size, the parallel mode is applied. Note that a configuration may also be adopted in which, when the size of the sheet S exceeds the predetermined size, the non-parallel mode is applied, and the size of the sheet S is smaller than or equal to the predetermined size, the parallel mode is applied.

FIG. 11 is a flowchart showing a mode switching method that is based on a sheet size. In S1101, the CPU 601 (the condition determination section 614) obtains size information of the sheets S. The condition determination section 614 specifies the size of the sheets S based on a detection result of the size sensor 608, size information input through the operation panel 607, or size information included in job information.

In S1102, the CPU 601 (the condition determination section 614) determines whether or not the size of the sheets S is larger than or equal to a predetermined size. The predetermined size is, for example, the LGL size. If the size of the sheets S is larger than or equal to the predetermined size, the CPU 601 advances the procedure from S1102 to S703, and applies the non-parallel mode. If the size of the sheets S is smaller than the predetermined size, the CPU 601 advances the procedure from S1102 to S710, and applies the parallel mode.

In this manner, the parallel mode and the non-parallel mode are switched in accordance with the size of the sheets S. In particular, when the non-parallel mode is applied, even a sheet S whose length L in the conveyance direction is larger than or equal to a predetermined length Lth can be a portion of a booklet. Specifically, conveyance, stacking, alignment, and bonding can be applied to even the sheet S whose length L in the conveyance direction is larger than or equal to the predetermined length Lth. Here, the predetermined length Lth may also be the length of a heat-press region of the heat-press unit 51 in the conveyance direction of the sheets S. On the other hand, the parallel mode is applied to a sheet S whose length L is shorter than the predetermined length Lth, and thus conveyance performance, stackability, alignment accuracy, and productivity of the sheet bundle W are realized at a high level. Note that the size of each sheet S does not exceed the maximum stackable size of the stacking section 42.

### Others

In the above embodiment, the post-processing apparatus 130 including the heat-press unit 51 is disposed alongside the image forming apparatus 100. However, this is merely an example.

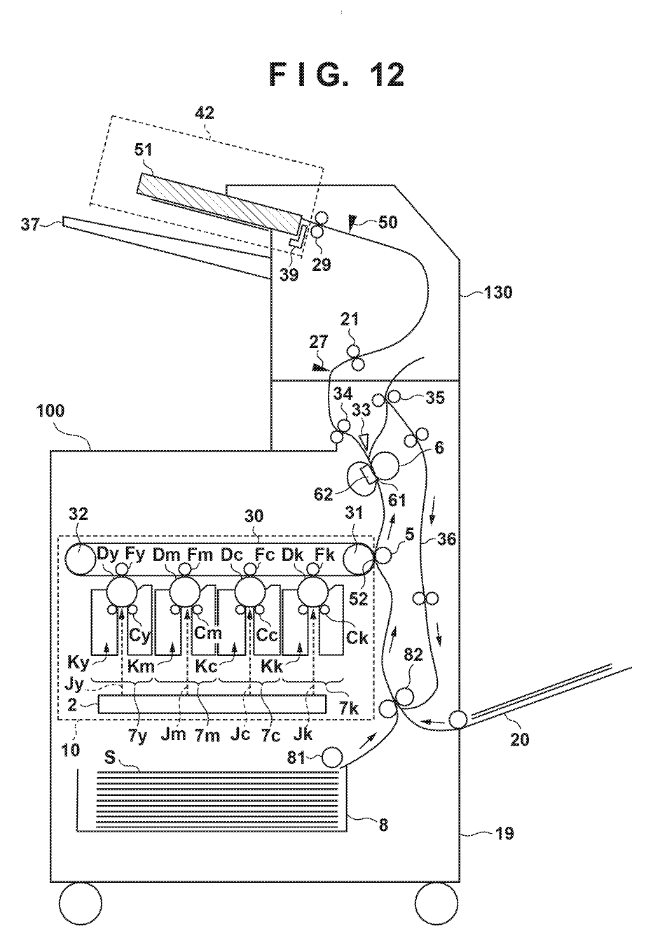

As shown in FIG. 12, the post-processing apparatus 130 and the heat-press unit 51 may be arranged in an upper portion of the main body of the image forming apparatus 100. In this case, the discharge rollers 34 directly deliver each sheet S to the post-processing apparatus 130. When the sheet sensor 27 detects the leading edge of the sheet S, the inlet rollers 21 convey the sheet S. Furthermore, the pair of kick-out rollers 29 convey the sheet S to the stacking section 42. Note that the direction in which the sheet S is conveyed to the stacking section 42 in FIG. 12 is opposite to the conveyance direction in which the sheet S is conveyed to the stacking section 42 in FIG. 3A.

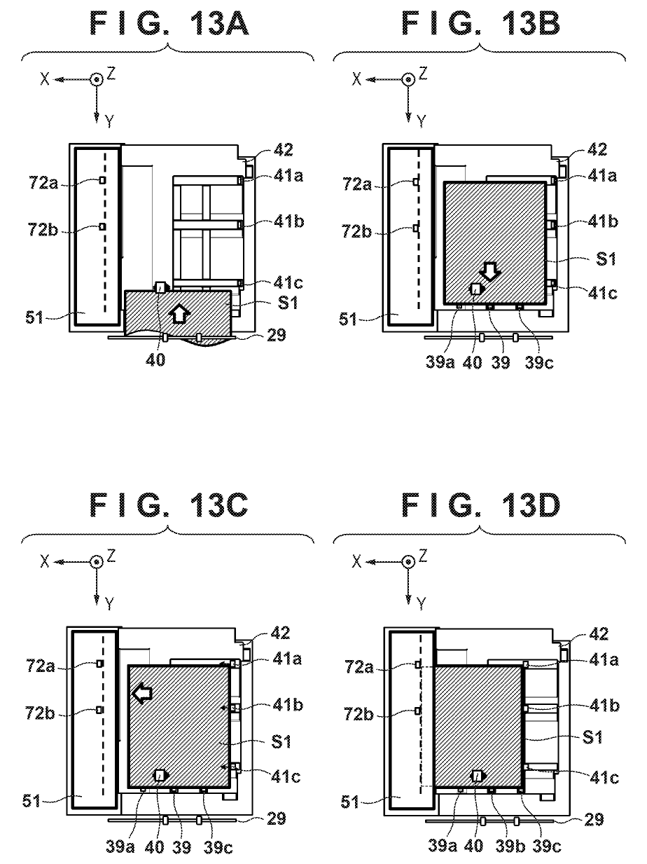

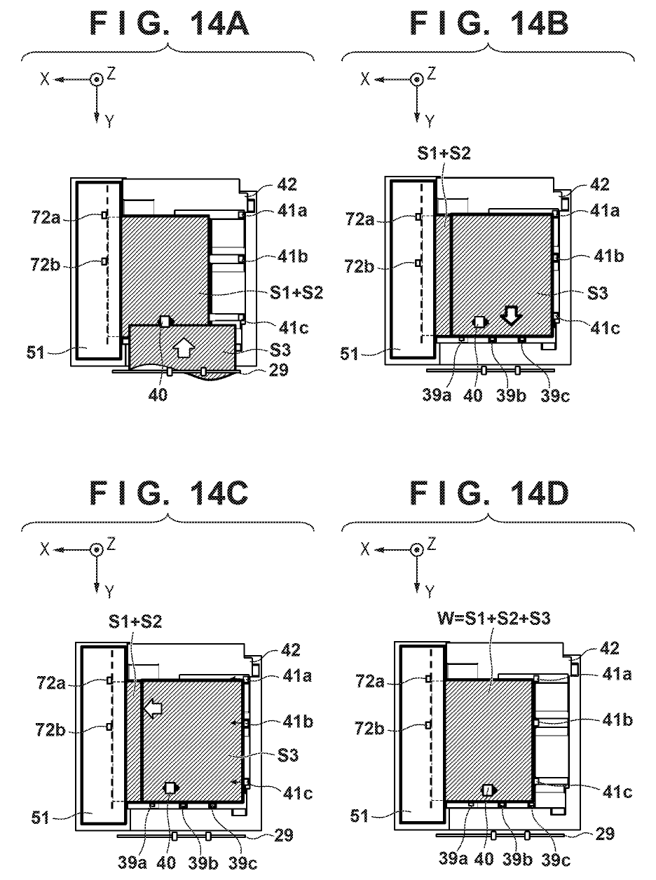

FIGS. 13A-13D and 14A -14D show a booklet producing operation that is executed on the stacking section 42. An initial state is a state where the stacking section 42 is empty. As shown in FIG. 12, there is no buffer section 80, and thus each sheet bundle W is formed on the stacking section 42.

In FIG. 13A, the contact portions 39a to 39c of the longitudinal aligning plate 39 and the lateral aligning plates 41a to 41c of the lateral alignment jogger 41 are disposed at the standby positions thereof. The sheet S1 is conveyed in the -Y direction by the pair of kick-out rollers 29 and the aligning roller 40. As shown in FIG. 13B, when the trailing edge of the sheet S1 moves beyond the contact portions 39a to 39c, the pair of kick-out rollers 29 and the aligning roller 40 stop. Furthermore, the aligning roller 40 starts reverse rotation to convey the sheet S1 in the +Y direction. The trailing edge of the sheet S1 is abutted against the contact portions 39a to 39c, and the trailing edge of the sheet S1 is aligned.

As shown in FIG. 13C, the lateral aligning plates 41a to 41c of the lateral alignment jogger 41 start lateral alignment. The lateral aligning plates 41a to 41c move in the +X direction to push the sheet S1 out toward the lateral reference plates 72a and 72b. As shown in FIG. 13D, the lateral aligning plates 41a to 41c cause the side end portion (left side) of the sheet S1 to abut against the lateral reference plates 72a and 72b, thereby realizing lateral alignment of the sheet S1. By repeating the processes shown in FIGS. 13A -13D, formation, longitudinal alignment, and lateral alignment of the sheet bundle W formed by a plurality of sheets S are realized. In the above example, the sheet bundle W is formed of five sheets S, but this is merely an example. Here, for convenience of explanation, it is assumed that the sheet bundle W is formed of two sheets S.

As shown in FIG. 14A, the sheet bundle W is formed of sheets S1 and S2. The lateral aligning plates 41a to 41c have already returned to the standby positions. The heat-press unit 51 has executed the bonding processing on the sheet bundle W. When the non-parallel condition is not satisfied, the parallel mode is applied. During the bonding processing of the sheet bundle W, the pair of kick-out rollers 29 convey a subsequent sheet S3 to the stacking section 42, so as to stack the sheet S3 on the preceding sheet bundle W. Note that the aligning roller 40 either moves to a standby position in the +Z direction so as not to interfere with conveyance of the sheet S3, or is freely rotatable. When the non-parallel condition is satisfied, the non-parallel mode is applied. By coming into contact with the sheet S3 and starting reverse rotation, the aligning roller 40 causes the sheet S3 to abut against the contact portions 39a to 39c, and starts longitudinal alignment of the sheets S. As shown in FIG. 14C, upon completion of the bonding processing on the preceding sheet bundle W, the pressurizing lever 504 is raised, and the lateral aligning plates 41a to 41c start to move. As shown in FIG. 14D, the sheet S3 abuts against the lateral reference plates 72a and 72b, thereby realizing lateral alignment of the sheet S3.

On the other hand, in the non-parallel mode, after the bonding processing performed on the sheet bundle W is complete, the subsequent sheet S3 is conveyed by the pair of kick-out rollers 29, and the sheet S3 is stacked on the preceding sheet bundle W. As shown in FIG. 14B, the subsequent sheet S3 is conveyed to the stacking section 42 by the pair of kick-out rollers 29, and is stacked on the preceding sheet bundle W. By coming into contact with the sheet S3 and starting reverse rotation, the aligning roller 40 causes the sheet S3 to abut against the contact portions 39a to 39c, thereby executing longitudinal alignment of the sheet S. As shown in FIG. 14C, the lateral aligning plates 41a to 41c start to move. As shown in FIG. 14D, the sheet S3 abuts against the lateral reference plates 72a and 72b, thereby realizing lateral alignment of the sheet S3.

In this manner, also in the image forming system 1, in which the post-processing apparatus 130 is installed in an upper portion of the image forming apparatus 100, can switch between the parallel mode and the non-parallel mode.

### Summary

The pair of kick-out rollers 29 are an example of a conveyance unit that conveys sheets S to which an adhesive was applied. The stacking section 42 is an example of a support unit that accepts and supports the sheets S conveyed by the conveyance unit. The heat-press unit 51 is an example of a bonding unit that moves relative to the support unit, and bonds, with an adhesive, a sheet bundle W formed by a plurality of sheets S supported by the support unit. A parallel mode is an example of a first mode in which, while the bonding unit is executing bonding processing on a preceding sheet bundle W, a subsequent sheet S is stacked on the preceding sheet bundle W. A non-parallel mode is an example of a second mode in which, after bonding processing performed on the preceding sheet bundle W by the bonding unit is complete, the subsequent sheet S is stacked on the preceding sheet bundle W. The controller 600 and the CPU 601 are examples of a control unit that controls the conveyance unit and the bonding unit. The non-parallel condition is an example of a condition on which stackability for stacking the subsequent sheet S on the preceding sheet bundle W is decreased. As shown in FIG. 7 and the like, when this condition is satisfied, the second mode is selected. When this condition is not satisfied, the first mode is selected. According to the present embodiment, the post-processing apparatus 130 is provided that is capable of switching between a mode in which bonding processing of a preceding sheet bundle W and stacking processing of a subsequent sheet S are executed in parallel, and a mode in which they are not executed in parallel.

For example, the condition includes that the type of a plurality of sheets S forming the preceding sheet bundle W is a type that is prone to curling. For example, the condition includes that the environment in which the post-processing apparatus 130 is installed is an environment in which sheets are likely to curl. For example, the condition may be that the temperature of the environment in which the post-processing apparatus 130 is installed exceeds 30° C, and the humidity of the environment exceeds 80%. For example, the condition may include the number of sheets S forming a preceding sheet bundle W exceeding a predetermined number of sheets (e.g., 30 sheets). The condition may be that the length L of the sheet S in the conveyance direction in which the sheet S is conveyed from the conveyance unit to the support unit is longer than the predetermined length Lth. The condition may be that the length L of a sheet S in the conveyance direction in which the sheet S is conveyed from the conveyance unit to the support unit is longer than the predetermined length Lth, and that an adhesive is applied one of two corners of the sheet in the conveyance direction. This is because these may cause post-processing performance of a subsequent sheet S to decrease.

The motor M8 is an example of a moving unit. As shown in FIG. 10D, the motor M8 moves the support unit or the bonding unit such that an adhesive on a preceding sheet bundle W1 stacked on the support unit is disposed at the bonding position of the bonding unit. As shown in FIG. 10E, upon completion of bonding processing on the preceding sheet bundle W1, the motor M8 moves the support unit or the bonding unit such that the preceding sheet bundle W1 is spaced away from the bonding position. When the length L of a sheet S exceeds the predetermined length Lth, the motor M8 needs to move the sheet bundles W1 and W2 by moving the movable unit 59. This is because the adhesive image Aim needs to be disposed under the heat-press region of the heat-press unit 51.

The movable unit 59, the lateral alignment jogger 41, and the like are examples of an aligning unit that aligns one or more sheets supported by the support unit in a first direction, and aligns the sheets in a second direction orthogonal to the first direction. The lateral reference plates 72a and 72b are also an example of the aligning unit.

The adhesive is toner. Note that an adhesive other than toner may be adopted as long as the adhesive can be applied to a sheet S. The bonding unit (e.g., the heat-press unit 51) is configured to heat and press a preceding sheet bundle W including the sheet S to which the adhesive was applied.

The buffer section 80 functions as a producing unit that produces the sheet bundle W by overlaying a plurality of sheets S. The conveyance unit (the pair of kick-out rollers 29) conveys the sheet bundle W to the support unit. Note that, instead of producing the sheet bundle W in the buffer section 80, the sheet bundle W may be produced on the stacking section 42.

The movable unit 59 is an example of a first aligning unit that aligns sheets S supported by the support unit, in a first direction (Y direction). The lateral alignment jogger 41 and the lateral reference plates 72a and 72b are an example of a second aligning unit that aligns the sheets S supported by the support unit, in a second direction (e.g., the X direction) orthogonal to the first direction. The first direction is a sheet conveyance direction. The second direction is a direction in which the sheets S approach the bonding unit. The longitudinal aligning plate 39 is an example of a first reference member disposed in parallel to the second direction. The aligning roller 40 functions as a first abutting unit that causes the end portions of the sheets S to abut against the first reference member. The lateral reference plates 72a and 72b are an example of a second reference member disposed in parallel to the first direction. The lateral aligning plates 41a and 41b are an example of a second abutting unit that causes the end portions of the sheets S to abut against the second reference member. In a first mode, the second abutting unit causes a preceding sheet bundle W to abut against the second reference member, the bonding unit starts bonding processing, and the second abutting unit returns to the standby position. Furthermore, the conveyance unit stacks a subsequent sheet S on the preceding sheet bundle W that is undergoing the bonding processing, and the first abutting unit causes the subsequent sheet S to abut against the first reference member. Furthermore, the bonding unit ends the bonding processing on the preceding sheet bundle, and the second abutting unit causes the preceding sheet bundle W and the subsequent sheet S to abut against the second reference member. Furthermore, the bonding unit starts the bonding processing on a new sheet bundle W+S formed by the preceding sheet bundle W and the subsequent sheet S.

In a second mode, the second abutting unit causes a preceding sheet bundle W to abut against the second reference member, the bonding unit starts bonding processing, the second abutting unit returns to the standby position, and the bonding unit ends the bonding processing on the preceding sheet bundle W. Furthermore, the conveyance unit stacks a subsequent sheet S on the preceding sheet bundle W for which the bonding processing has been ended, the first abutting unit causes the subsequent sheet S to abut against the first reference member, and the second abutting unit causes the preceding sheet bundle W and the subsequent sheet S to abut against the second reference member. The bonding unit starts bonding processing on a new sheet bundle W+S formed by the preceding sheet bundle W and the subsequent sheet S. The image forming section 10 is an example of an image forming unit that forms an image on a sheet S. The process cartridge 7k is an example of an applying unit that applies an adhesive to the sheet S. Note that one of the process cartridges 7y, 7m, and 7c may function as the applying unit, or a fifth process cartridge that has transparent toner may function as the applying unit. The image forming system 1 is an example of an image forming apparatus.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050554, filed March 25, 2025, which is hereby incorporated by reference herein in its entirety.

What is claimed is:

1. A post-processing apparatus comprising:
a conveyance unit configured to convey a sheet to which an adhesive was applied;
a support unit configured to accept and support the sheet conveyed by the conveyance unit;
a bonding unit configured to move relative to the support unit and to bond, with the adhesive, a sheet bundle formed by a plurality of sheets and supported by the support unit; and
a control unit configured to control the conveyance unit and the bonding unit and having a first mode in which, while the bonding unit is executing bonding processing on a preceding sheet bundle, a subsequent sheet is stacked on the preceding sheet bundle, and a second mode in which, after bonding processing performed on a preceding sheet bundle by the bonding unit is complete, a subsequent sheet is stacked on the preceding sheet bundle,
wherein the second mode is selected in a case where a condition according to which post-processing performance of the subsequent sheet decreases relative to the preceding sheet bundle is satisfied, and the first mode is selected in a case where the condition is not satisfied.

2. The post-processing apparatus according to claim 1, wherein the condition includes that a type of the plurality of sheets forming the preceding sheet bundle is a type prone to curling.

3. The post-processing apparatus according to claim 1, wherein
the condition includes that an environment in which the post-processing apparatus is installed is an environment that makes a sheet likely to curl.

4. The post-processing apparatus according to claim 1, wherein
the condition is that a temperature of an environment in which the post-processing apparatus is installed exceeds 30° C, and a humidity of the environment exceeds 80%.

5. The post-processing apparatus according to claim 1, wherein
the condition includes that a total number of sheets that form the preceding sheet bundle exceeds a predetermined number of sheets.

6. The post-processing apparatus according to claim 1, wherein
the condition is that a length of a sheet in a conveyance direction in which the sheet is conveyed from the conveyance unit to the support unit is longer than a predetermined length.

7. The post-processing apparatus according to claim 1, wherein
the condition is that a length of a sheet in a conveyance direction in which the sheet is conveyed from the conveyance unit to the support unit is longer than a predetermined length, and the adhesive was applied to one of two corners in the conveyance direction of the sheet.

8. The post-processing apparatus according to claim 1, further comprising
a moving unit configured to move the support unit or the bonding unit such that the adhesive on the preceding sheet bundle stacked on the support unit is disposed at a bonding position of the bonding unit, and to move the support unit or the bonding unit such that, upon completion of the bonding processing on the preceding sheet bundle, the preceding sheet bundle is separated away from the bonding position.

9. The post-processing apparatus according to claim 1, further comprising
an aligning unit configured to align one or more sheets supported by the support unit, in a first direction and in a second direction orthogonal to the first direction.

10. The post-processing apparatus according to claim 1, wherein
the adhesive is a toner.

11. The post-processing apparatus according to claim 1, wherein
the bonding unit is configured to heat and press the preceding sheet bundle including the sheet to which the adhesive was applied.

12. The post-processing apparatus according to claim 1, further comprising
a producing unit configured to produce a sheet bundle by overlaying a plurality of sheets,
wherein the conveyance unit conveys the sheet bundle to the support unit.

13. The post-processing apparatus according to claim 1, further comprising:
a first aligning unit configured to align a sheet supported by the support unit, in a first direction; and
a second aligning unit configured to align the sheet supported by the support unit, in a second direction orthogonal to the first direction,
wherein the first direction is a conveyance direction of the sheet, and
the second direction is a direction in which the sheet approaches the bonding unit.

14. The post-processing apparatus according to claim 13, wherein
the first aligning unit includes:
a first reference member disposed in parallel with the second direction, and
a first abutting unit configured to cause an end portion of the sheet to abut against the first reference member.

15. The post-processing apparatus according to claim 14, wherein
the second aligning unit includes:
a second reference member disposed in parallel with the first direction, and
a second abutting unit configured to cause an end portion of the sheet to abut against the second reference member, and
in the first mode,
the second abutting unit causes the preceding sheet bundle to abut against the second reference member,
the bonding unit starts bonding processing,
the second abutting unit returns to a standby position,
the conveyance unit stacks the subsequent sheet on the preceding sheet bundle undergoing the bonding processing,
the first abutting unit causes the subsequent sheet to abut against the first reference member,
the bonding unit ends the bonding processing on the preceding sheet bundle,
the second abutting unit causes the preceding sheet bundle and the subsequent sheet to abut against the second reference member, and
the bonding unit starts bonding processing on a new sheet bundle formed by the preceding sheet bundle and the subsequent sheet.

16. The post-processing apparatus according to claim 15, wherein
in the second mode,
the second abutting unit causes the preceding sheet bundle to abut against the second reference member,
the bonding unit starts bonding processing,
the second abutting unit returns to the standby position,
the bonding unit ends the bonding processing on the preceding sheet bundle,
the conveyance unit stacks the subsequent sheet on the preceding sheet bundle for which the bonding processing ended,
the first abutting unit causes the subsequent sheet to abut against the first reference member,
the second abutting unit causes the preceding sheet bundle and the subsequent sheet to abut against the second reference member, and
the bonding unit starts bonding processing on a new sheet bundle formed by the preceding sheet bundle and the subsequent sheet.

17. An image forming apparatus comprising:
an image forming unit configured to form an image on a sheet;
an applying unit configured to apply an adhesive to the sheet;
a conveyance unit configured to convey the sheet to which the adhesive was applied;
a support unit configured to accept and support the sheet conveyed by the conveyance unit;
a bonding unit configured to move relative to the support unit and to bond, with the adhesive, a sheet bundle formed by a plurality of sheets and supported by the support unit; and
a control unit configured to control the conveyance unit and the bonding unit and having a first mode in which, while the bonding unit is executing bonding processing on a preceding sheet bundle, a subsequent sheet is stacked on the preceding sheet bundle, and a second mode in which, after bonding processing performed on a preceding sheet bundle by the bonding unit is complete, a subsequent sheet is stacked on the preceding sheet bundle,
wherein the second mode is selected in a case where a condition according to which post-processing performance of the subsequent sheet decreases relative to the preceding sheet bundle is satisfied, and the first mode is selected in a case where the condition is not satisfied.
